(19) United States
(12) Patent Application Publication
(10) Pub. No.: US 2015/0085856 A1
(43) Pub. Date: Mar. 26, 2015

(54) REGISTERING A DEVICE WITH A VoIP CORE NETWORK

(71) Applicant: ORANGE, Paris (FR)

(72) Inventor: Bertrand Bouvet, Perros Guirec (FR)

(21) Appl. No.: 14/361,680

(22) PCT Filed: Nov. 28, 2012
(86) PCT No.: PCT/FR12/52734

§ 371 Date: May 29, 2014

(30) Foreign Application Priority Data
Nov. 30, 2011 (FR) 1160957

(51) Int. Cl. H04L 29/06

(52) U.S. Cl. CPC H04L 65/1073
USPC 370/352

(57) ABSTRACT

Disclosed are a management method and server suitable for managing a request issued by a device on a VoIP core network for the purpose of registering a current address of contact of the device. The management method comprises, on receiving the request, obtaining a number of addresses of contact registered on the core network in association with the public identifier of the device. When that number has reached a maximum registration capacity defined for the public identifier, an interrogation message is sent to the addresses of contact registered on the core network in association with the public identifier if, at the end of a predetermined time period, at least one of the addresses of contact has not responded to said interrogation message or is declared as being inactive in response to the interrogation message, accepting the request. Otherwise the request is rejected.

### BACKGROUND OF THE INVENTION

The invention relates to the general field of telecommunications.

It relates more particularly to managing requests issued by devices such as a terminal or a home gateway to register those devices with a voice over Internet protocol (IP) core network.

In particular, the invention applies in preferred but non-limiting manner to an IP multimedia subsystem (IMS) network as defined by the third generation partnership project (3GPP) and implementing session initiation protocol (SIP). Nevertheless, the invention also applies to other voice over IP (VoIP) core network architectures, e.g. such as an H323 or a REGISTRAR SIP core network, and also to core networks using other protocols for applying voice over IP, such as the extensible messaging and presence protocol (XMPP), or proprietary protocols.

Whatever the protocol under consideration for applying voice over IP, the operation of the core network is much the same. On starting, a VoIP device registers itself with the core network by sending it a registration request, which request includes in particular a public identifier (or identity) and an address of contact of the device.

The public identifier of the device may for example be a VoIP telephone number, an electronic address, or an SIP address (a uniform request identifier (URI)), as used by the public for reaching the device. It may in particular be the IP multimedia public (IMPU) identity for an IMS core network. The public identifier can be shared by a plurality of devices; these devices also have respective private identifiers (or identities) (e.g. an IP multimedia private identifier (IMPI) for an IMS core network), which may be the same for each of the devices or for a group of devices, or in a variant may be different for each device.

The address of contact of the device corresponds to its reachability address in the IP domain, and in known manner it comprises the IP address of the device, a port number associated with its VoIP stack, and the transport protocol used by the device for communicating (e.g. user data protocol (UDP), transport control protocol (TCP), transport layer security (TLS)).

The correspondence between the public identifier of the device and its address of contact is stored in a registration table that is also known as the registration context, which table is maintained by the VoIP core network.

As a result, when a caller issues a call to the public identifier of the device, that call is routed to the VoIP core network, which uses the public identifier to determine the address of contact of the device. The VoIP core network then redirects the call to the address of contact.

Generally, the VoIP device registers with the core network using its address of contact on a first occasion when it starts (this is referred to as initial registration), and then it re-registers using the same address of contact (this is referred to as subsequent registration), e.g. periodically with a period of one hour. Provision is also made for a de-registration request to be sent by the device to the core network, when the device is closed down properly.

Nevertheless, various types of incident can cause a VoIP device to change its current address of contact, but without it having the opportunity beforehand to de-register properly with the core network (i.e. by sending a de-registration request to the core network). This can happen for example:
after the device has restarted automatically as a result of an anomaly in its operation or as the result of a process in the device crashing;
after physical disconnection of the line connecting the device to the network;
for an IP access of the asynchronous digital subscriber line (ADSL) type, after loss of ADSL synchronization;
after a change of network or in a roaming situation for devices in compliance with the long-term evolution (LTE) standard; and
etc.

Following the change of its current address of contact, the device needs to inform the VoIP core network of its new address, and it needs to do this in order to remain reachable. For this purpose, it transmits a registration request to the core network, which request contains its public identifier and its new current address of contact.

Various policies may be implemented by the operator of the VoIP core network in order to manage the registration requests it receives, such as for example:
no verification, i.e. all registration requests are accepted (this is never done in practice);
verification based on using one or more queues associated with the registration table and operating in a first-in-first-out (FIFO) mode (e.g. a queue by public identifier or a queue associated with a pair comprising a public identifier and a private identifier, written [public identifier and a private identifier] pair). More precisely:
   for a queue of size 1: the core network accepts the new address of contact as received in the registration request, and registers it in the registration table associated with the public identifier contained in the request as a replacement, where appropriate, for the previously stored address of contact for this public identifier; and
   for a queue of size greater than 1: if the queue (i.e. the registration table) is not full, the request is accepted and the new address of contact is added to the addresses of contact present in the registration table associated with the public identifier contained in the request. If the queue is full (in other words if the maximum registration capacity has been reached for the public identifier or for the pair constituted by the public identifier and the private identifier), then the core network accepts the request and registers the new address of contact in the registration table as a replacement for the existing address of contact that has been registered for the longest or that has the shortest current expiry duration for a registration; and
blocking: once the maximum registration capacity for a given public identifier has been reached, the core network rejects any incoming registration request for this public identifier.

The operators of VoIP core networks generally adopt verification of registration requests based on a configuration of the registration table as one or more FIFO mode queues of size 1.

Nevertheless, that type of verification presents limits and cannot be envisaged, in particular when the core network operator seeks to install mechanisms that preserve the registration of certain devices considered as being priority devices (e.g. because de-registration of those devices might lead to a malfunction that the user finds troublesome, such as a loss of VoIP services).

To illustrate this possibility, consider by way of example a home gateway GW associated with an address of contact AoC1 and that shares a common public identifier IMPU with a terminal P (e.g. a mobile telephone or a tablet fitted with VoIP application software, sometimes also referred to as a “softphone”), with the core network being configured to accept a maximum of two simultaneous registrations associated with that one public identifier IMPU (i.e. a priori a registration for the gateway and a registration for the terminal). Also assume firstly that the registration table (i.e. the queue) maintained by the core network for the public identifier IMPU initially contains only the address of contact AoC1 of the gateway GW, and secondly that the core network is configured so as to avoid ejecting the gateway GW from the queue when a device (e.g. the terminal P) issues a registration request with the core network using the same public identifier IMPU and an address of contact that has not yet been registered, while the queue is itself full.

Assume now that there is a restart of the home gateway GW even before it has been able to de-register itself properly from the core network, and that as a result of the restart the home gateway has a new current address of contact AoC1′. The gateway GW thus presents a registration request to the VoIP core network containing the public identifier IMPU and the new address of contact AoC1′. Since the queue is not full, the new address of contact AoC1′ is stored in the registration table in association with the public identifier IMPU.

In other words, as a result of the sudden restart of the gateway, the queue associated with the public identifier IMPU contains both the old address of contact AoC1 (now inactive, i.e. no longer used for the gateway GW) and also the new address of contact AoC1′ of the gateway GW. The maximum registration capacity for the public identifier IMPU has just been reached.

In the present state of the art, when the core network receives a registration request corresponding to a public identifier already registered in its registration tables, it is not capable of telling whether the request comes from a device that is already registered in its tables but that is using a different address of contact, or whether it comes from another device (possibly a forbidden device) seeking to register with the core network and sharing the public identifier.

It can then readily be understood that given the configuration of the registration table and the associated queue and in order to avoid ejecting the gateway GW, the core network will refuse any new registration request (typically a request coming from the terminal P) containing a not yet registered address of contact together with the public identifier IMPU. The terminal P therefore has no solution for enabling it to register with the core network other than waiting for the “automatic” expiry of the remanent registration (e.g. one hour maximum if devices re-register once every hour with the core network) and the resulting deletion of the inactive address of contact AoC1 of the gateway GW from the queue.

In other words, the core network will wrongly refuse to register the terminal P in order to avoid taking the risk of ejecting the gateway GW from the registration table. It can thus readily be understood that such a situation is not satisfactory for the user of the terminal P since it may in particular make the VoIP service unavailable for quite a long time.

### OBJECT AND SUMMARY OF THE INVENTION

The invention serves in particular to improve this situation by proposing a method of managing a request issued by a device associated with a public identifier for the purpose of registering on a voice over IP core network a current address of contact of the device for the core network, the management method comprising:
on receiving the request, an obtaining step of obtaining a number of addresses of contact registered on the core network in association with the public identifier; and
a comparison step of comparing this number with a maximum registration capacity defined for said public identifier.

The management method of the invention is remarkable in that when said number of addresses of contact registered on the core network in association with the public identifier has reached this maximum capacity, it further comprises:
a sending step of sending an interrogation message to the addresses of contact registered on the core network in association with the public identifier;
if, at the end of a predetermined time period, at least one of the addresses of contact from among these addresses has not responded to the interrogation message or has been declared as being inactive in response to said interrogation message, an acceptance step of accepting the request of the device; and
otherwise a rejection step of rejecting the request.

Correspondingly, the invention also provides a management server for managing a request issued by a device associated with a public identifier, for the purpose of registering with a voice over IP core network a current address of contact of the device on the voice over IP core network, the management server comprising:
means that are activated on receiving the request to obtain a number of addresses of contact registered on the core network in association with the public identifier; and
comparison means for comparing this number with a maximum registration capacity defined for said public identifier.

The management server of the invention is remarkable in that it further comprises means that are activated when the number of addresses of contact registered on the core network in association with the public identifier has reached this maximum capacity:
to send an interrogation message to said addresses of contact registered in association with said public identifier;
to accept the request if, at the end of a predetermined period, at least one of the addresses of contact from among these addresses has not responded to said interrogation message or has been declared as being inactive in response to said interrogation message; and
otherwise to reject the request.

In the invention, a registration of a current address of contact of a device on a core network refers to an initial registration of the device with its current address of contact on the core network. The invention does not relate to managing re-registrations proper of devices.

Various types of request issued for the purpose of registration (i.e. necessary for a registration) of the device with the core network may be managed in accordance with the invention.

Thus, in the invention, the term “request issued by a device for the purpose of registering on the core network” is used to mean in particular a registration request issued by the device and constituted for example by a specific device registration message provided by the protocol used by the core network, such as an SIP REGISTER message for the SIP protocol. In known manner, such a registration request contains the current address of contact of the device together with its public identifier.

However, the invention is not limited to managing registration requests properly speaking issued by devices. It also relates to a request sent by a device prior to registering its current address of contact on the core network, in particular a request for the purpose of obtaining or exchanging information required for the registration. By way of example, such a request may be a Hypertext transfer protocol (HTTP) Get Parameter seeking to obtain a VoIP configuration file for the device as is required to enable it to register on the core network.

Furthermore, the invention is preferably used to manage requests for the purpose of registering on the core network an address of contact for a device that is not already registered with the core network for the public identifier associated with that device (in other words, requests issued in association with registering a new address of contact associated with the public identifier for the core network). Specifically, registering an address of contact that is already registered with the core network as an initial registration of the device and not as a re-registration, indicates that there has been a malfunction of the network that lies outside the scope of the invention, and that the person skilled in the art can easily detect and manage in known manner.

In the meaning of the invention, the term “interrogation message” designates a message that calls for a response on the part of its destination, in other words, a message to which the destination identified in the message responds in normal time on receiving the message.

Preferably, the message selected as an interrogation message is a message that does not disturb the progress of any calls or data exchanges in which the destination device of the interrogation message is already participating, i.e. the interrogation message is transparent for ongoing sessions in the destination device (e.g. because it is a message handled by the lower protocol layers of the device).

By way of example, such a message is a message enquiring about the capacities of the remote party, in particular such as an SIP OPTIONS message for a core network using the SIP protocol, or an AUDITENDPOINT message for a core network using the media gateway control protocol (MGCP) protocol. These messages are processed by the lower layers of the protocol stack of the destination device and processing them has no impact properly speaking on the progress of ongoing sessions associated with the device, unlike other messages that are managed at the level of the application layers of the stack, such as for example an SIP INVITE message, which, on arrival, can give rise in particular to the device ringing.

It is naturally possible to envisage other interrogation messages, such as in particular an SIP MESSAGE message containing text to which the destination responds in normal operation by means of a 200 OK message after displaying the text.

By analyzing the responses and/or the non-responses to the interrogation messages sent out, the invention thus makes it possible to identify quickly and easily the addresses of contact that are registered with the core network in association with the public identifier of the device and that are no longer in use (i.e. that are inactive), e.g. as a result of new addresses of contact being allocated to the devices that were previously registered for those addresses of contact. The invention makes it possible to avoid unjustified rejection of registration requests resulting from the presence of inactive addresses of contact in the registration tables of the core network when such inactive addresses have not been properly de-registered.

With the invention there is no need to wait for the registration durations to expire in order to be able to register a new address of contact. The invention thus makes it possible to limit the period during which VoIP services are unavailable to a device that is seeking to register after a change in its address of contact, e.g. resulting from an unexpected restart.

Also, the invention generates only very little traffic on the network. Specifically, an interrogation message is sent to the addresses of contact of the registration table only in the event of its maximum capacity being reached.

The invention thus makes it possible to optimize the resources of the core network by providing better availability of the voice over IP service in exchange for few resources (small exchanged messages).

The invention is particularly pertinent since numerous situations exist nowadays in which addresses of contact are changed (e.g. as a result of devices restarting) and/or are to be expected in future telecommunications networks (e.g. in the event of a handover from one access network to another, in roaming situations, etc.).

Furthermore, in accordance with the invention, if all of the addresses registered with the core network are active, i.e. if before the expiry of the predetermined period of time all of the registered addresses correspond to “current” addresses of contact of devices such that all of them responded to the interrogation message or are declared as being active in response to the interrogation message (e.g. by intermediate equipment such as a session border controller (SBC) located in series in the data stream for registration with the core network between those devices and the core network) then the request is rejected. As a result of this request being rejected, it is not possible for the device to register with the core network using its current address of contact. To some extent, the invention thus makes it possible to prevent a device that ought not to register with the core network, given the registration capacity authorized for a given public identifier, from being able to register and take the place of an authorized device.

It should be observed that the management method of the invention may be performed at various locations in the IP network, e.g. by equipment in the voice over IP core network or by equipment situated outside the core network.

Thus, by way of example, the invention may be performed in particular for managing registration requests by means of a registration server of the core network, such as a serving-call state control function (S-CSCF) server for an IMS SIP core network, or a PROXY REGISTRAR server for a non-IMS SIP core network, suitable for updating registration tables associated with the public identifiers.

In a variant, the invention can equally well be performed by equipment that is external to the core network (e.g. a computer system of the VoIP operator) that by way of example is in charge of pre-selecting devices that can present registration requests with the core network, given the number of addresses of contact that are already registered for a given public identifier, this equipment being suitable for interrogating the core network in order to obtain this number.

In a particular implementation of the invention, during the acceptance step, the current address of contact of the device is registered on the core network in association with the public identifier as a replacement for an address of contact that has not responded to the interrogation message or that has been declared inactive in response to the interrogation message.

Correspondingly, in this implementation, the management server means for accepting the request are suitable for registering the current address of contact of the device on the core network in association with the public identifier as a replacement for an address of contact that has not responded to the interrogation message or that has been declared inactive in response to the interrogation message.

This implementation makes it possible to update the registration table associated with the public identifier of the device with its current address of contact, so as to finalize registration of the device with the core network.

There exists a preferred application in particular when the management method of the invention is performed for managing registration requests by a registration server of the core network that is suitable for modifying the registration table associated with the public identifier contained in the request (e.g. by an S-CSCF server in an IMS core network).

Thus, for example, when a plurality of addresses of contact have not responded to the interrogation message or have been declared inactive in response to the interrogation message, the current address of contact of the device may be registered as a replacement for the address of contact that corresponds to the shortest registration expiry duration among said plurality of addresses of contact that have not responded to the interrogation message or that have been declared inactive in response to the interrogation message.

This serves to delete the oldest registered (or re-registered) address of contact from among the unused (i.e. inactive) addresses in the registration table.

In another example, when a plurality of addresses of contact have not responded to the interrogation message or have been declared inactive in response to the interrogation message, the current address of contact of the device is registered as a replacement for the address of contact that is associated with a lowest priority among said plurality of addresses of contact.

For a VoIP core network using the SIP protocol, this priority may be determined for example with the help of the “q” field of the address of contact defined by the RFC3261 document entitled “SIP: Session Initiation Protocol” published by the Internet engineering task force (IETF) and contained in the registration request that enabled this address of contact to be registered on the core network.

In another implementation of the invention, prior to accepting the request, the management method further comprises a verification step of verifying that at least one address that has not responded to the interrogation message or that has been declared inactive in response to the interrogation message corresponds to the shortest registration expiry duration among the addresses of contact registered with the core network in association with the public identifier, the request issued by the device being rejected otherwise.

This implementation has a preferred application when the management method is performed by equipment that is distinct from the registration server of the core network, and the core network applies a “FIFO” type policy for managing the registration of addresses of contact, which policy consists in ejecting the address of contact, if any, that corresponds to be shortest registration expiry duration.

In another implementation of the invention, if a plurality of addresses of contact have not responded to the interrogation message or have been declared inactive in response to the interrogation message at the end of said predetermined time period, the management method further comprises a de-registration step of de-registering these addresses from said core network.

During this de-registration step, all of the addresses of contact that are not pertinent because they are inactive or have not been correctly de-registered are thus advantageously deleted from the registration table corresponding to the public identifier as maintained by the core network. In this manner, subsequent registration procedures undertaken by devices with the core network will take place more quickly.

The de-registration step may also include notifying at least one server of the VoIP core network, such as for example a proxy call session control function (P-CSCF) server or an application server that these addresses have been de-registered.

In an implementation, the interrogation message may be re-issued a plurality of times during the predetermined time period to at least one of the addresses of contact.

This makes it possible to mitigate potential problems in transmission and/or reception of interrogation messages and/or of their responses. Furthermore, the equipment to which the interrogation message is sent has several occasions on which it can respond to the message (in particular if it is busy and cannot respond to the first message sent).

In an implementation of the invention, the device is also associated with a private identifier, and the management method is performed while taking into consideration the addresses of contact registered on the core network in association with the pair constituted by the public identifier and the private identifier associated with the device.

In other words, the invention provides a method of managing requests that can easily be configured so as to take into account:
either all of the addresses of contact registered for a given public identifier independently of the private identifier of the device seeking registration;
or only the addresses of contact registered for a given public identifier that correspond to the private identifier of the device seeking registration or that correspond to determined private identifiers (e.g. all of the private identifiers associated with the same public identifier excepting one or more predefined private identifiers that may correspond, for example, to priority devices), or all of the private identifiers associated with the device seeking registration (e.g. corresponding to devices of the same type as the device seeking registration), etc.

Thus, the invention may advantageously be used with various different ways of operating the core network, i.e. equally well:
in a mode of operation in which a plurality of pieces of equipment or devices share both the same public identity and the same private identity; or
in a mode of operation in which they share the same public identity but have distinct private identities (e.g. the mode of operation standardized under the name “Shared IMPU” in the 3GPP standard for IMS core networks); or else
in a mode of operation that is a hybrid between those two modes of operation.

In a variant implementation of the invention, the interrogation message is also sent to the addresses of contact registered on the core network in association with the public identifier of the device when the maximum capacity has not been reached. This may be performed on each occasion, e.g. each time a request is received for registering a current address of contact of a device, or at a predetermined time intervals (e.g. periodically).

By analyzing the responses received to this interrogation message (or in equivalent manner the responses that are not received), this makes it possible to clean up the registration table corresponding to the public identifier independently of its maximum capacity being reached. This serves to limit induced phenomena of registrations being blocked, and registration procedures proper are accelerated.

In a particular implementation, the various steps of the management method of the invention are determined by computer program instructions.

Consequently, the invention also provides a computer program on a data medium, the program being suitable for being performed in a management server or more generally in a computer, the program including instructions adapted to performing steps of the management method as described above.

This computer program may use any programming language, and it may be in the form of source code, object code, or code intermediate between source code and object code, such as in a partially compiled form, or in any other desirable form.

The invention also provides a computer readable data medium, including instructions of a computer program as mentioned above.

The data medium may be any entity or device capable of storing the program. For example, the medium may comprise storage means such as a read only memory (ROM), for example a compact disk (CD) ROM or a microelectronic circuit ROM, or indeed magnetic recording means, e.g. a floppy disk or a hard disk.

Furthermore, the data medium may be a transmissible medium such as an electrical or optical signal, which may be conveyed via an electrical or optical cable, by radio, or by other means. The program of the invention may in particular be downloaded from a network of the Internet type.

Alternatively, the data medium may be an integrated circuit in which the program is incorporated, the circuit being adapted to execute or to be used in the execution of the method in question.

In another aspect, the invention also provides a system for a voice over IP core network, the system comprising:
a management server in accordance with the invention, suitable for managing a request issued by a device associated with a public identifier for the purpose of registering a current address of contact of the device on the core network; and
at least one registration table for the public identifier, the table containing at least one address of contact that is distinct from the current address and that is registered on the core network in association with said public identifier, said at least one registration table being consulted by said server on receiving the request, in order to obtain the number of addresses of contact that are registered on the core network in association with the public identifier.

The system of the invention has the same advantages as the management method and server of the invention as described above.

In other implementations, it is also possible to envisage that the management method, the management server, and the system of the invention present in combination all or some of the above-mentioned characteristics.

### BRIEF DESCRIPTION OF THE DRAWINGS

Other characteristics and advantages of the present invention appear from the following description made with reference to the accompanying drawings which show implementations having no limiting character.

In the figures:

FIG. 1 is a diagrammatic view of a system and a management server in accordance with the invention in a particular embodiment;

FIG. 2 shows an example of a registration table maintained by the management server shown in FIG. 1;

FIG. 3 is a diagram showing the hardware architecture of the management server in the FIG. 1 embodiment;

FIG. 4 is a flow chart showing the main steps of a management method of the invention when performed in an implementation of the invention by the server shown in FIG. 1;

FIGS. 5A and 5B show different states of the registration table maintained by the management server shown in FIG. 1;

FIG. 6 shows a registration table associated with a [public identifier, private identifier] pair; and

FIG. 7 is in the form of a flow chart showing the main steps of a management method of the invention when it is performed in another implementation of the invention by a management server external to the core network.

### DETAILED DESCRIPTION OF THE INVENTION

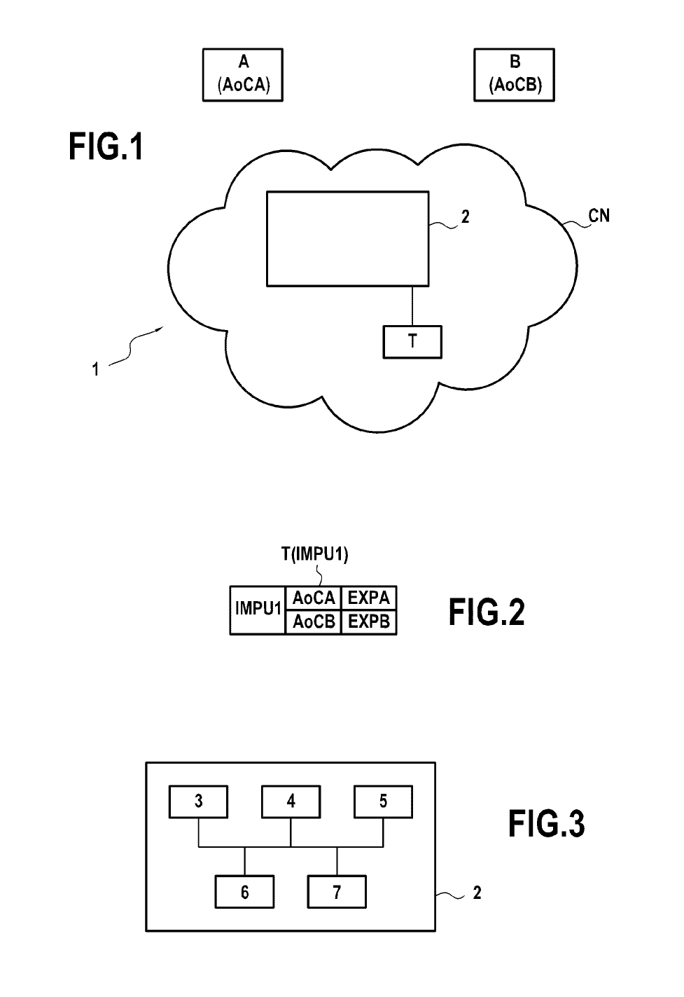

FIG. 1 shows, in its environment, a system 1 comprising voice over IP core network CN in accordance with the invention in a particular embodiment.

The system 1 serves to manage requests issued to the core network CN in order to register a current address of contact of a device with the core network.

In the presently-described embodiment, the voice over IP core network CN is an IMS core network using SIP protocol. Nevertheless and as mentioned above, these assumptions are not limiting, with the invention being equally applicable to other VoIP core network architectures (e.g. H323, MGCP, Peer2Peer, REGISTRAR), and also to other VoIP applications protocols, such as for example XMPP, and to other proprietary protocols.

In the presently-described example, attention is given more particularly to management requests issued by devices A and B sharing the same public identity (or identifier) IMPU1. In this example, the identifier IMPU1 is an IMPU identity of conventional type as defined by the 3GPP standard, in particular in the document 3GPP TS 23.228 entitled “IP multimedia subsystem”, Release 9, September 2010.

In this example, the devices A and B are respectively a terminal (e.g. a telephone, a digital tablet, etc.) and a domestic gateway, each equipped with a VoIP stack. Nevertheless, the invention also applies to other types of device equipped with a VoIP stack, such as for example servers, etc.

Each device A and B is provided with a respective current address of contact AoCA, AoCB: as mentioned above, this address of contact represents an address where the device can be reached in the IP domain, and in particular it comprises the IP address of the device, a port number associated with its VoIP stack, and also the transport protocol (e.g. UDP, TCP, TLS) used by the device in order to communicate in the IP domain.

In accordance with the invention, the system 1 comprises a management server 2 in accordance with the invention and registration tables (or contexts) T associated respectively with each public identifier (or with each [public identifier, private identifier] pair) in association with which a registration request has been sent to the core network.

In the present example, a registration table associated with a given public identifier or with a given [public identifier, private identifier] pair is used to mean any data structure that makes it possible to store information about registrations made for this given public identifier or for this given [public identifier, private identifier] pair. Such a table is itself known and is not described in detail herein.

Each registration table associated with a public identifier (or with a [public identifier, private identifier] pair) contains in particular the addresses of contact of the devices that are registered in associated with the public identifier (or in association with the [public identifier, private identifier] pair), together with the expiry duration of the registrations (the value of the parameter “Expires” in the SIP protocol).

It should be observed that a registration table associated with a given public identifier may itself be made up of a plurality of distinct “sub-tables”, each sub-table being associated with a pair made up of this given public identifier and a distinct private identifier, and containing the addresses that have been registered in association with this pair.

The maximum number of addresses of contact that can be registered in the table is fixed, e.g. by the operator of the core network, and it depends on the intended policy for verifying registrations associated with the same public identifier (or with the same [public identifier, private identifier] pair). This number constitutes a maximum capacity Cmax of registrations for a public identifier (or for a [public identifier, private identifier] pair) in the meaning of the invention. It may vary as a function of the identifiers, of the types of device that is it desired to register (e.g. if the verification policy makes a distinction between devices at the time of registration), etc.

In the example shown in FIG. 2, the table T(IMPU1) associated with the public identifier IMPU1 corresponds to a maximum capacity Cmax=2 and contains the current addresses of contact AoCA and AoCB of the devices A and B together with respective expiry durations EXPA and EXPB for these registrations.

In the presently-described embodiment, the management server 2 is incorporated in the S-CSCF registration server of the core network CN. In known manner, the S-CSCF server of a VoIP core network is in charge of registrations in the core network, and in particular it is suitable for managing and modifying the registration tables associated with the various public identifiers.

In this example, the server has the hardware architecture of a computer as shown diagrammatically in FIG. 3. In particular, it comprises a processor 3, a random access memory (RAM) 4, a ROM 5, a non-volatile rewritable memory 6 (e.g. storing the registration tables maintained by the server 2), and communications means 7, in particular using the SIP protocol and themselves known.

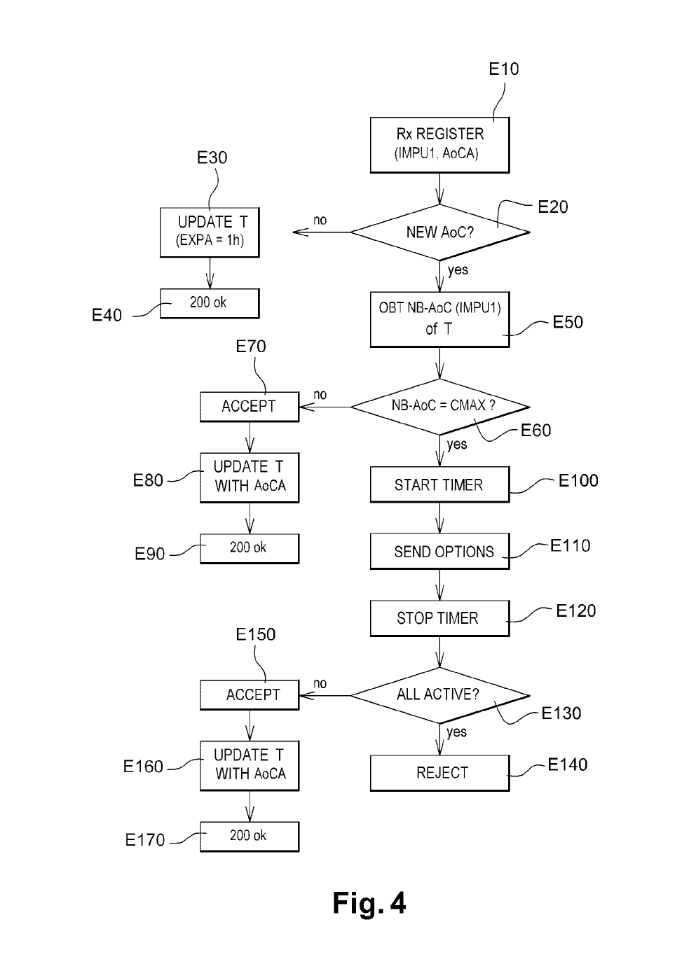

The ROM 5 of the server 2 constitutes a storage medium in accordance with the invention, which medium is readable by the processor 3 and stores a computer program in accordance with the invention, the program including instructions for executing steps of the request management method in accordance with the invention as described below with reference to FIG. 4, in a particular implementation.

In order to illustrate this implementation, it is assumed in this example that the server 2 processes a registration request issued by the terminal A to the core network CN. In this example, the request is an SIP REGISTER message containing in particular the public identifier IMPU1 of the terminal A together with its current address of contact AoCA.

On receiving this request (step E10), the management server 2 determines whether the address of contact AoCA is a new address of contact that has not yet been registered for the identifier IMPU1, or whether the request is in fact a request to re-register the terminal AoCA (step E20).

In the presently-described SIP implementation, the management server 2 acts for this purpose to extract the dialog identifier present in known manner in the SIP register request, and determines whether the dialog identifier corresponds to a dialog that is already established with the core network.

If so, the received request is a re-registration request, in other words the current address of contact AoCA is already registered in the table T(IMPU1) (response “no” to the test in step E20): the server 2 then updates the registration expiry duration EXPA associated in the table T(IMPU1) with the terminal A (step E30). For example, EXPA=1 hour.

It then sends a response message to the terminal A containing the value of the duration EXPA (step E40). In this example, the response message is an SIP 200 OK message containing a parameter EXPIRES=1 hour.

In contrast, if the management server 2 determines that the received request is not a re-registration request but rather an initial registration request (response “yes” for the test in step E20), it searches its non-volatile rewritable memory 6 to discover whether there exists a registration table T(IMPU1) associated with the public identifier IMPU1.

If one does exist, the management server 2 consults the registration table and verifies initially that the address of contact AoCA has not yet been registered in association with the public identifier IMPU1 in this table. As mentioned above, if the address of contact AoCA is already registered in the table T(IMPU1), then the management server 2 deduces a malfunction of the network that it can signal in known manner, in particular by sending an error message to the terminal A.

In this example it is assumed that such a table does already exist in the memory 6 of the management server 2 (which table may for example have been created during an earlier registration using the public identifier IMPU1).

By consulting this registration table, the management server 2 obtains the number Nb-AoC of addresses of contact that are already registered in association with the public identifier IMPU1, using means that are themselves known and not described in detail herein (step E50).

It then compares this number Nb-AoC with the maximum registration capacity Cmax associated with the identifier IMPU1, in order to determine whether the maximum registration capacity has already been reached (step E60).

If Nb-AoC is less than Cmax (response “no” to the test of the step E60), the management server 2 accepts the registration request from the terminal A (step E70).

In the presently-described example, the management server 2 then updates the registration table T(IMPU1) by adding the current address of contact AoCA of the terminal A together with a registration expiry duration EXPA equal to 1 hour (step E80), and it sends a 200 OK message containing the duration EXPA to the terminal A (step E90).

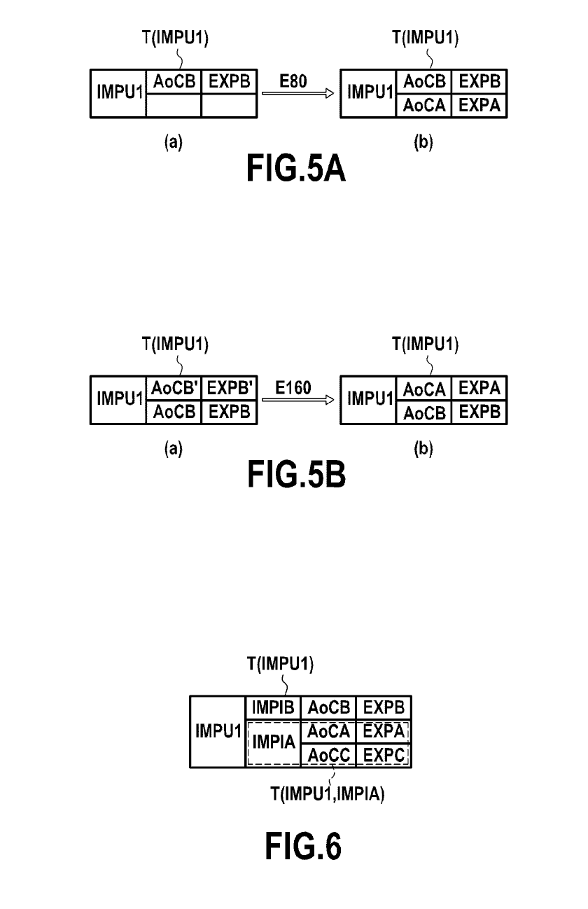

FIG. 5A shows an example of such updating when the table T(IMPU1) initially contains a single address of contact (state (a) in FIG. 5A), namely the address of contact AoCB of the gateway B. At the end of updating (state (b) in FIG. 5a), the table T(IMPU1) contains the address of contact AoCB of the gateway B together with the address of contact AoCA of the terminal A. The maximum registration capacity associated with the public identifier IMPU1 has thus been reached.

In contrast, if at the end of the comparison step E60, the management server 2 detects that the maximum registration capacity has already been reached (response “yes” to the test of step E60), in the presently-described implementation it starts a timer t for a predetermined period of time written d (step E100).

In this example, the period d is selected to enable the management server 2 to respond to the registration request from the terminal A within the response time limits specified by the core network (in other words, in this example, in compliance with the response time defined by the 3GPP standard for IMS core networks, namely 32 seconds), so as to ensure that the additional steps performed by the management server 2 in order to determine whether or not it is going to accept the registration request are themselves transparent for the terminal A.

FIG. 5B shows an example of the table T(IMPU1) in which the maximum registration capacity has been reached: in this example, the gateway B is registered with two addresses of contact AoCB and AoCB′ associated with respective registration durations EXPB and EXPB′ (state (a) in FIG. 5B).

Then, in accordance with the invention, the management server 2 sends an interrogation message to all of the addresses of contact registered in the table T(IMPU1) in association with the public identifier IMPU1, in order to determine whether the addresses of contact are still active, i.e. still in use as current addresses of contact by the devices that have requested their registration (step E110).

As mentioned above, an interrogation message in the meaning of the invention is a message that calls for a response from its destination, in other words it is a message to which the destination identified in the message responds in normal time on receiving the message.

The interrogation message is preferably selected so as to avoid disturbing ongoing sessions (e.g. calls) already taking place in the devices to which it is sent. In the presently-described implementation, the interrogation message is an SIP OPTIONS message that, in the request URI (RURI) of the message, contains the address of contact to which the message is being sent, and in the FROM field, contains the identifier of the management server 2.

In the example shown in FIG. 5B, the management server 2 thus sends an SIP OPTIONS messages to the address of contact AoCB and an SIP OPTIONS message to the address of contact AoCB′.

Thereafter, the management server 2 waits for responses to the interrogation messages it has sent, until the expiry of the timer t (step E120).

In a variant implementation, if the management server 2 does not receive a response from one or more addresses of contact to which it has sent an interrogation message within determined time intervals before the expiry of the timer t, it retransmits the interrogation message one or more times (e.g. twice) to the address of contact before the expiry of the timer t, in order to mitigate potential transmission problems between the management server 2 and the device associated with the address of contact.

At the end of the period d (i.e. at the expiry of the timer t), the management server 2 determines whether all of the addresses of contact to which it has sent an interrogation message are active.

In the presently-described implementation, and for a network configuration similar to that shown in FIG. 1, the management server 2 acts for this purpose by determining whether it has received responses to the interrogation messages from all of the addresses of contact listed in the table T(IMPU1), i.e. the addresses of contact AoCB and AoCB′ in the example shown in FIG. 5B (step E130). By way of example the response messages may be SIP 200 OK messages if the device is available, or a 486 Busy Here message if the device is already in communication.

Under such circumstances (response “yes” to the test of step E130), the management server 2 deduces that all of the addresses of contact registered in the table T(IMPU1) are active and it therefore rejects the registration request from the terminal A (step E40). For example, it sends an SIP 403 Forbidden message to the terminal A.

In contrast, if at least one address of contact has not responded at the end of the time period d to the interrogation message sent by the management server 2 (response “no” to the test of step E130), the management server 2 deduces that this address of contact is no longer active (e.g. because the device that was registered with this address of contact has changed its current address of contact or has been turned off) and there is no longer any need for this address to remain registered in the table T(IMPU1). In accordance with the invention, the management server 2 therefore accepts the registration request issued by the terminal A.

Furthermore, in the presently-described implementation, the management server 2 updates the registration table T(IMPU1) with the current address of contact AoCA of the terminal A and with the expiry duration EXPA (step E160), and then sends an SIP 200 OK message in association with the expiry duration of the registration EXPA=1 hour to the terminal A in order to inform the terminal A that its registration request has been accepted (step E170).

Several situations may arise when updating the table T(IMPU1) in step E160:

1) only one address of contact has not responded to the interrogation message sent by the management server 2; or

2) a plurality of addresses of contact have not responded to the interrogation message sent by the management server 2 (assuming that the maximum registration capacity is greater than 1).

In situation 1), the management server 2 de-registers the address of contact that did not respond (in other words it deletes it from the registration table T(IMPU1)), and as a replacement for that address, it registers the current address of contact AoCA of the terminal A in the table T(IMPU1) together with its expiry duration EXPA.

FIG. 5B shows such updating.

In the example shown in FIG. 5B, it is assumed by way of example that the gateway B was restarted suddenly while it was using the address of contact AoCB′ and that it was not able to de-register with the core network CN prior to restarting. After restarting, it is assumed that the gateway B has maintained as its current address of contact the address AoCB, leaving the address AoCB′ inactive, such that the table T(IMPU1) contains two addresses of contact AoCB′ and AoCB that are associated with respective expiry durations EXPB′ and EXPB (state (a) of the table T(IMPU1) in FIG. 5B).

Since the gateway B is no longer using the address of contact AoCB′, the management server 2 does not receive a response message from this address to the interrogation message that was sent in step E110. Thus, during updating step E160 it deletes the inactive address of contact AoCB′ (together with its expiry duration EXPB′) from the table T(IMPU1), and replaces it with the address of contact AoCA of the terminal A (together with its expiry duration EXPA) (state (b) of the table T(IMPU1) in FIG. 5B).

In situation (2), various updating policies may be envisaged, firstly for identifying which address of contact is to be deleted from the table in order to register the current address of contact of the terminal A, and secondly for processing the other addresses of contact that have not responded to the interrogation message.

In the presently-described implementation, the management server 2 ejects (i.e. de-registers from the core network CN) the address of contact that has not responded to the interrogation message and that corresponds to the shortest expiry duration, and as a replacement for this address it registers the address of contact AoCA in the table T(IMPU1) together with its expiry duration EXPA. On the assumption that all of the devices are configured to send re-registration messages to the core network using the same time period, it should be observed that this implementation is equivalent to registering the address of contact of the terminal A as a replacement for the address of contact corresponding to the oldest registration.

Furthermore, in the presently-described implementation, the management server 2 also ejects from the table T(IMPU1) (i.e. de-registers from the core network) the other addresses of contact that have not responded to the interrogation message at the end of the duration d. This serves to clean up the registration table by removing inactive addresses of contact so as to simplify and accelerate subsequent registrations. This updating of the registration table also makes it possible to avoid sending pointless messages over the network, in particular on the arrival of an incoming call (SIP INVITE message) to a public identifier registered with the core network. In compliance with the 3GPP standard, when a plurality of addresses of contact are associated with the same public identifier in the core network, the SIP INVITE message is presented to each of the addresses of contact. The invention thus makes it possible to limit pointless retransmissions of the SIP INVITE message to the addresses of contact that are no longer active.

In a variant implementation, these other addresses of contact are not deleted from the table.

In yet another variant implementation, the step of de-registering the inactive address(es) of contact from the core network may also be accompanied by notifying at least one server of the VoIP core network such as for example a proxy call session control function P-CSCF server or an application server about the deletion of this/these address(es) from the registration table.

Other policies for updating the table may be envisaged in order to determine which address of contact is to be deleted from the table in order to register the current address of contact of the terminal A.

Thus, by way of example, one alternative might consist in ejecting the address of contact that is associated with the lowest priority from among the addresses of contact that have not responded to the interrogation message.

This priority may be determined by the management server 2 consulting the value of the “q” field provided in the address of contact by the IETF standard for the SIP protocol, which field is described in the above-mentioned document RFC3261. In accordance with that document, the “q” field is a real lying in the range 0 to 1, the value 1 designating a device of maximum priority, while the value 0 designates the lowest priority (and no value for “q” is equivalent to a value q=0). This field is present in particular in each registration request for an address of contact sent to the core network. In order to implement this alternative, the registration table should also associate the corresponding value of the field “q” with each stored address of contact (i.e. the value that was contained in the registration request that enables the address of contact to be registered in the core network).

In a variant, the priority of a device may be associated with a range of IP addresses in which its address of contact is to be found. For example, it is possible to envisage associating different types of device with various ranges of addresses of contact as a function of the priority of the devices: thus, a first range of addresses may be associated with high priority devices such as gateways, a second range of addresses may be associated with terminals connected behind the gateway, and a third range of addresses may be associated with terminals connected to access points that are accessible in a roaming situation, this third range of addresses defining a category of lower priority devices in the “core network usage” meaning of the term.

In the presently-described implementation with reference to the network configuration shown in FIG. 1, the management server 2 determines whether the addresses of contact are active by detecting the presence (or absence) of responses received from those addresses of contact to the interrogation messages sent. In this configuration, the response messages are relayed as far as the management server 2.

Nevertheless, the invention also applies to other network configurations, and in particular to a network configuration in which intermediate pieces of equipment such as session border controllers (SBCs) are provided in managing registrations between the core network CN and the devices to which the management server 2 sends the interrogation messages, e.g. for the purpose of reducing the load on the management server 2 and for ensuring regular traffic to the access. In such a configuration, the response messages from the devices are received by the intermediate equipment; likewise the absence of response messages at the end of the period d is detected by such intermediate equipment. Thereafter, the intermediate equipment in turn sends a message specifying the activity or the inactivity of the address of contact to the management server 2.

Thus, in such a network configuration, during the step E130, in order to determine whether all of the addresses of contact to which an interrogation message has been sent are active at the end of the period d, the management server 2 analyzes whether all of the messages received from the intermediate equipment in response to the interrogation messages inform it that the devices associated with those addresses of contact are active.

If so (response “yes” to the test of step E130), the management server 2 deduces that all of the addresses of contact registered in the table T(IMPU1) are active and it rejects the registration request from the terminal A (step E140).

In contrast, if the at the end of the time period d it receives for at least one address of contact a message from intermediate equipment specifying that in response to the interrogation message the device associated with a particular address of contact is inactive (e.g. a 480 No Route Found message), it deduces that the address of contact is no longer active (response “no” to the test in step E130). In accordance with the invention, the management server therefore accepts the registration request issued by the terminal A.

Correspondingly, the address(es) of contact for ejecting from the registration table, in particular to make it possible to register the address of contact of the terminal A, is/are selected from the addresses of contact declared inactive by the intermediate equipment in response to the interrogation messages sent by the management server 2.

Naturally, the invention also applies to hybrid network configurations in which intermediate equipment is present, but only for some of the devices that might register with the core network CN. Under such circumstances, prior to accepting the registration request issued by the terminal A, the management server 2 verifies whether, at the end of the time period d, at least one address of contact has not responded to the interrogation message or has been declared as being inactive by intermediate equipment in response to the interrogation message (e.g. via a 480 No Route Found message). Correspondingly, the address(es) of contact for ejecting from the registration table is/are selected from among those addresses of contact that have not responded to the interrogation messages sent by the management server 2 or that have been declared inactive by intermediate equipment in response to those interrogation messages.

In the examples described above to illustrate the invention, attention is given to managing a registration request issued by the terminal A and to a registration table containing two addresses of contact for the gateway B, one of which is inactive. Naturally, the invention applies to other situations, such as for example when the registration table T(IMPU1) contains an address of contact of the gateway B and an address of contact for the terminal A that is inactive and distinct from its current address of contact, which inactive address has not been de-registered from the core network.

In the presently-described implementation, the registration request is managed for a public identifier independently of the policy applied in the core network concerning allocating private identifiers to devices that share the public identifier (e.g. a common private identifier for all of the devices sharing the same public identifier, or distinct private identifiers for each of the devices, or a hybrid mechanism in which distinct private identifiers are allocated to distinct groups of devices).

In another implementation of the invention, the management server 2 performs the invention by also taking account of the private identifiers of the devices, which identifiers are also contained in the registration requests issued by the devices. More precisely, in this implementation, the steps of the method of the invention as described above with reference to FIG. 4 are then performed on the basis of a registration table T(IMPU1, IMPIA) associated with the pair constituted by the public identifier IMPU1 and the private identifier IMPIA of the terminal, and taking into consideration the addresses of contact registered in this table (e.g. Nb-AoC corresponds to the number of registrations in the table associated with the [public identifier, private identifier] pair of the terminal A, Cmax corresponds to the maximum registration capacity associated with this pair, and the address of contact AoCA is registered, where applicable, as a replacement for an address of contact in the table T(IMPU1, IMPIA)).

FIG. 6 shows an example of a registration table T(IMPU1, IMPIA) associated with the pair T(IMPU1, IMPIA) of the terminal A and incorporated in the table T(IMPU1) associated with the public identifier IMPU1. In this example, the private identifier IMPIA is shared by the terminal A and by another device C, while the gateway B has a distinct private identifier IMPIB. The devices A, B, and C share the same public identifier IMPU1. Registration requests are managed by the core network with the help of queues associated with each [public identifier, private identifier] pair.

Thus, in the various implementations described, the invention makes it possible to manage registrations either by taking account solely of the public identifier contained in the register (independently of the policy for allocating private identifiers as applied by the core network, e.g. same private identifier shared by a plurality of devices or one distinct private identifier for each device), or by taking account both of the public identifier and of the private identifier contained in the register.

In the presently-described implementation, the management server 2 sends an interrogation message only when the maximum registration capacity is reached in the registration table associated with the public identifier IMPU1 or in the registration table associated with the pair formed by the public identifier IMPU and the private identifier IMPI. In a variant, a similar interrogation message may be sent to the addresses of contact of the table independently of the fact that the maximum capacity has been reached, e.g. periodically, in order to clean up the registration table regularly by removing addresses of contact that are inactive. The address of contact that do not reply to such an interrogation message at the end of a predetermined duration (which may be identical with the duration d, or different) are then deleted from the table T(IMPU1) or T(IMPU1, IMPIA) by the management server 2.

Furthermore, in the presently-described implementation, the management server 2 is incorporated in the registration server of the core network CN. In other words, the management server 2 is suitable for modifying the registration table associated with the public identifier IMPU1 or with the [public identifier IMPU1, private identifier IMPIA] pair. Nevertheless, this assumption is not limiting and the invention also applies when the management server 2 does not have that capacity.

For example, in another implementation, the management server 2 may be a server that is external to the core network CN (e.g. located in the information system of the network), and that is suitable for preselecting devices that might issue registration requests with the core network CN, given the number of addresses of contact already registered for a given public identifier (or a given [public identifier, private identifier] pair), and more precisely requests to the registration server of the core network CN that is in a position to update the registration tables and to accept or reject the registration requests as a function of the policy applied in the core network CN.

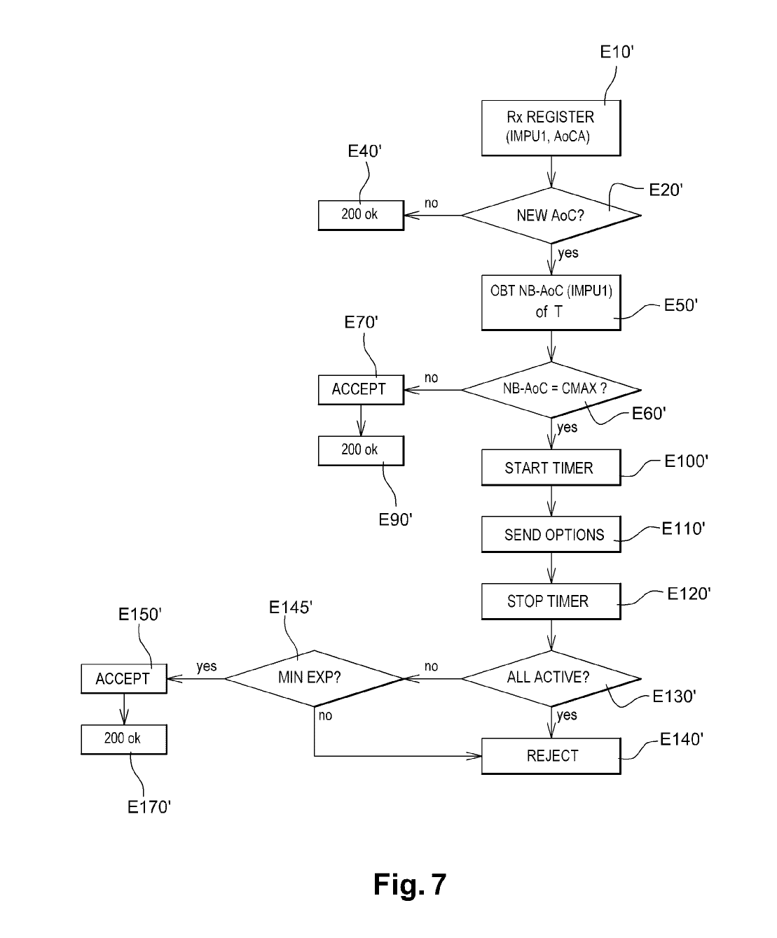

The steps performed during the management method of the invention by the management server in this other implementation are shown in FIG. 7. In the example shown in this figure, the management of a request issued for registration on the core network CN is managed in accordance with the invention by taking account solely of the public identifier contained in the request. Naturally, this implementation also applies when account is also taken of the private identifier contained in the request.

In this implementation, the steps E10′, E20′, E40′ to E70′, E90′, E100′ to E150′, and E170′ as performed by the management server (and the associated variants) are similar to the steps E10, E20, E40 to E70, E90, E100 to E150, and E170 described above with reference to FIG. 4 (in contrast, the steps E30, E80, and E160 of updating the registration table are not implemented by the management server). The information needed for performing the invention (e.g. the number of addresses of contact and the addresses of contact registered in the registration table) is nevertheless obtained by the management server by using the public identifier, for example to interrogate the registration server of the core network CN by means of the standard SIP procedure described in the above-mentioned IETF document RFC3261 (i.e. sending an SIP REGISTER message containing the public identifier IMPU1 but without specifying the address of contact).

Furthermore, given the fact that in this implementation the policy for deleting and replacing addresses of contact in the registration table does not depend on the management server, prior to forwarding a registration request to the core network CN (in other words before accepting a registration request from a device), the management server must make sure that it is not going to trigger the eviction of an address of contact from the registration table that would be undesirable, e.g. because the address of contact is still active. By way of example, such a situation may arise when the core network implements a FIFO type policy based on the expiry durations of registrations, which policy consists in replacing the address of contact corresponding to the shortest registration expiry duration with the new address of contact.

In order to avoid such a situation, prior to accepting any registration request sent by the terminal A (in order words after receiving a response “no” to the test in step E130′ and before performing the step E150′), the management server determines whether from among the addresses of contact that have not responded to the interrogation message, one of them corresponds to the shortest expiry duration registered in the registration table (step E145′). By way of example, this step may be performed by interrogating the registration server of the core network CN.

Under such circumstances, the management server accepts the registration request from the terminal A (step E150′) and sends it an SIP 200 OK message (step E170′).

In contrast, if none of the addresses of contact that have not responded to the interrogation message corresponds to the shortest registration expiry duration registered in association with the public identifier INPU1, then the management server refuses the registration request from the terminal A (step E140′).

In the example shown in FIG. 7, the step E10′ is identical to the step E10 and consists in receiving an SIP REGISTER request issued by the terminal A to the core network CN. In a variant, the request received in step E10′ may be a request that is different from an SIP REGISTER message or more generally a request different from a specific message provided by the protocol being used by the core network for registering a device. In general terms, it may be an arbitrary request appropriate for registering the device.

Thus, by way of example, the request may be a message sent by the terminal A seeking to obtain a VoIP configuration file needed to enable it to register with the core network. Such a message may for example be an HTTP Get Parameter message containing the IP address of the terminal A. It should be observed that the terminal A obtaining the VoIP configuration file is essential for registering the terminal A with the core network (and more particularly registering its current address of contact), and forms part of the registration procedure performed by the terminal A in the sense that firstly obtaining such a configuration file is a prerequisite for registering the current address of contact of the terminal with the core network, and secondly obtaining this file is meaningful only because the terminal A is seeking to register its current address of contact with the VoIP core network in order to be able to communicate over the core network. A message requesting provision of this file thus constitutes, in the meaning of the invention, a request for registering a current address of contact of a device with the core network.

It should be observed that when the request managed by the method of the invention is such a message, the public identifier IMPU1 associated with the terminal A and used in particular for obtaining the number of addresses of contact Nb-AoC and the maximum registration capacity Cmax, may be recovered by the management server using the IP address of the terminal A as contained in the request, e.g. by interrogating an information system of the VoIP operator.

Furthermore, the steps E40′, E90′, and E170′ of accepting the request may then also include sending the requested VoIP configuration file to the terminal A (in known manner this file contains the public identifier of the terminal, its private identifier, the address of the point of entry to the VoIP core network, the domain name of the VoIP network, together with other fields associated with activating services on the VoIP core network).

In contrast, when the request is refused in step E140′, the requested VoIP configuration file is not sent to the terminal A.

In other implementations, it is also possible to envisage that the management method, the management server, and the system of the invention present in combination all or some of the characteristics described above with reference to FIGS. 1 to 7.

1. A management method of managing a request issued by a device associated with a public identifier, for the purpose of registering with a voice over IP core network a current address of contact of said device for the core network, said management method comprising:
on receiving said request, obtaining a number of addresses of contact registered on the core network in association with said public identifier; and
comparing this number with a maximum registration capacity defined for said public identifier;
wherein said management method further comprises, when said number has reached said maximum capacity:
sending an interrogation message to said addresses of contact registered on the core network in association with the public identifier;
if, at the end of a predetermined time period, at least one of the addresses of contact from among these addresses has not responded to said interrogation message or is declared as being inactive in response to said interrogation message, accepting the request of the device; and
otherwise rejecting the request.

2. A management method according to claim 1, wherein, during the acceptance process, the current address of contact of the device is registered on the core network in association with the public identifier as a replacement for an address of contact that has not responded to the interrogation message or that has been declared inactive in response to said interrogation message.

3. A management method according to claim 2, wherein, when a plurality of addresses of contact have not responded to the interrogation message or have been declared inactive in response to the interrogation message, the current address of contact of the device is registered as a replacement for the address of contact that corresponds to the shortest registration expiry time duration among said plurality of addresses of contact.

4. A management method according to claim 2, wherein, when a plurality of addresses of contact have not responded to the interrogation message or have been declared inactive in response to the interrogation message, the current address of contact of the device is registered as a replacement for the address of contact that is associated with a lowest priority among said plurality of addresses of contact.

5. A management method according to claim 4, wherein, the priority of the address of contact is determined by the field “q” defined in IETF document RFC3261.

6. A management method according to claim 1, wherein, prior to accepting said request, the method further comprises verifying that at least one address that has not responded to the interrogation message or that has been declared inactive in response to the interrogation message corresponds to the shortest registration expiry time duration among the addresses of contact registered with the core network in association with the public identifier, said request being rejected otherwise.

7. A management method according to claim 1, wherein, if a plurality of addresses of contact have not responded to the interrogation message or have been declared inactive in response to the interrogation message at the end of said predetermined time period, the method further comprises de registering these addresses from the core network.

8. A management method according to claim 1, wherein said interrogation message is re-issued a plurality of times during said predetermined time period to at least one of said addresses of contact.

9. A management method according to claim 1, wherein, when said voice over IP core network uses the SIP protocol, said interrogation message is an SIP OPTIONS message.

10. A management method according to claim 1, wherein said device is also associated with a private identifier, and said management method is performed while taking into consideration the addresses of contact registered on the core network in association with the pair constituted by the public identifier and the private identifier associated with the device.

11. A management method according to claim 1, wherein the interrogation message is also sent to the addresses of contact registered on the core network in association with the public identifier of the device when the maximum capacity has not been reached.

12. A computer program including instructions for executing steps of the management method according to claim 1, when said program is executed by a computer.

13. A management server for managing a request issued by a device associated with a public identifier, for the purpose of registering with a voice over IP core network a current address of contact of said device for the core network, said management server comprising:
a component configured to be activated on receiving said request to obtain a number of addresses of contact registered on the core network in association with said public identifier; and
a component configured to compare this number with a maximum registration capacity defined for said public identifier;
said management server further comprising a component configured to be activated when said number has reached said maximum capacity:
to send an interrogation message to said addresses of contact registered in association with said public identifier;
to accept the request if, at the end of a predetermined time period, at least one of the addresses of contact from among these addresses has not responded to said interrogation message or is declared as being inactive in response to said interrogation message; and
otherwise to reject the request.

14. A management server according to claim 13, wherein said component configured to accept the request is suitable for registering the current address of contact of the device on the core network in association with the public identifier as a replacement for an address of contact that has not responded to the interrogation message or that has been declared inactive in response to said interrogation message.

15. A management server according to claim 13, wherein it is incorporated in an S-CSCF server when the core network is an IMS core network.
